(19) United States
(12) Patent Application Publication
(10) Pub. No.: US 2026/0267124 A1
(43) Pub. Date: Sep. 10, 2026

(54) OPTICAL UNIT WITH CONTINUOUS PHASE AND AMPLITUDE CONTROL

(71) Applicant: Applied Materials Israel Ltd., Rehovot (IL)

(72) Inventors: Amir SHOHAM, Haifa (IL); Ilan Matan HURWITZ, Rishon LeZion (IL)

(21) Appl. No.: 19/072,858

(22) Filed: Mar. 6, 2025

(51) Int. Cl. G02B 21/14; G02B 5/30; G02F 1/01

(52) U.S. Cl. CPC G02B 21/14; G02B 5/3083; G02F 1/0136

(57) ABSTRACT

The present disclosure describes an optical unit comprising two or more controllable polarization dependent phase affecting elements, each having a ring-shaped phase affecting region surrounded by transmitting regions, and at least one polarization analyzer. The two or more controllable polarization dependent phase affecting elements and the at least one polarization analyzer are arranged along a common path of light propagation through the optical unit providing control over phase and attenuation level of light passing through the optical unit.

### TECHNOLOGICAL FIELD

The present disclosure relates to optical systems capable of selectively controlling phase and/or amplitude of light transmission, and is particularly related to control of phase and/or amplitude control of light collected by a phase contrast microscope system.

### BACKGROUND

The manipulation of the polarization, phase and intensity properties of light plays a role in various optical systems and applications, including imaging, telecommunications, and scientific instrumentation. Over time, advancements in birefringent materials, liquid crystals, and polarization analyzers have enabled significant improvements in controlling these properties.

Phase contrast microscopy, a technique developed by Zernike in 1935, revolutionized non-destructive imaging by converting phase variations in light passing through a sample into amplitude or intensity variations in the resulting image. This innovation facilitated numerous scientific breakthroughs, particularly in the observation of biological materials. Conventional phase contrast microscopy employs a transmission-based optical arrangement, which is optimal for substantially transparent samples.

For opaque or reflective samples, reflection-based phase contrast microscopy offers a valuable alternative. This technique visualizes phase variations or surface details in samples that are not limited to optical transparency, thereby broadening its range of applications.

### GENERAL DESCRIPTION

The present invention relates to an advanced optical unit designed to controllably modulate the phase and/or amplitude of light using polarization properties. The optical unit comprises two or more controllable polarization-dependent phase-affecting elements, each featuring a ring-shaped phase-affecting region surrounded by optically transparent regions. These phase-affecting elements are arranged along a common path of light propagation through the optical unit and operate in conjunction with at least one polarization analyzer. The combination of these components facilitates comprehensive control over the polarization state and phase delay of light traversing the unit.

In one embodiment, the controllable polarization-dependent phase-affecting elements are implemented as rotatable plates composed of birefringent materials. These plates are characterized by distinct fast and slow axes, oriented perpendicular to the direction of light propagation through the material. Depending on the configuration, these plates may include half-wavelength and quarter-wavelength retarders, providing a versatile means of achieving desired phase shifts and polarization transformations.

Another embodiment incorporates liquid crystal-based phase-affecting elements, such as liquid crystal modulators. More specifically, each of the controllable polarization-dependent phase-affecting elements is configured as a liquid crystal modulators having a ring-shaped active region. The axes of alignment of the active regions are orthogonal between the liquid crystal modulators, and are generally at a 45° angle with respect to polarization of input light. This configuration enables dynamic and high-precision control over phase modulation by adjusting modulation of the liquid crystal modulators, offering a practical solution for applications requiring rapid and programmable adjustments. The optical unit may further include a controller operable to selectively adjust the phase delay of the polarization-dependent phase-affecting elements, thereby enhancing the versatility and adaptability of the device.

The innovative design of the optical unit also includes the use of ring-shaped retarder regions, which allow for spatially selective phase and polarization control. By configuring the ring-shaped regions from birefringent materials and enabling rotation about an optical axis parallel to the light propagation direction, the unit can achieve a range of phase variations up to 2π and amplitude attenuation up to 100%. This functionality is particularly advantageous in applications requiring spatially resolved control of light, such as beam shaping, optical trapping, or advanced imaging systems.

In summary, the disclosed optical unit represents a significant advancement in the field of optical engineering. By integrating controllable phase-affecting elements with innovative ring-shaped geometries and polarization analyzers, the invention offers a compact, flexible, and highly effective solution for a wide range of optical applications.

Thus, according to a broad aspect, the present disclosure provides an optical unit comprising:
two or more controllable polarization dependent phase affecting elements, each having a ring-shaped phase affecting region surrounded by transmitting regions;
and at least one polarization analyzer;
wherein the two or more controllable polarization dependent phase affecting elements and the at least one polarization analyzer being arranged along a common path of light propagation through the optical unit.

According to some embodiments, the two or more controllable polarization dependent phase affecting elements are formed of rotatable plates carrying birefringent materials having a fast axis and a slow axis both perpendicular to direction of propagation of light through the material.

According to some embodiments, the two or more controllable polarization dependent phase affecting elements comprises at least one of a half wavelength plate or a quarter wavelength plate.

According to some embodiments, the two or more controllable polarization dependent phase affecting elements comprises a first ring-shaped half wavelength plate and a second ring-shaped quarter wavelength plate, and wherein the first ring-shaped half wavelength plate and the second ring-shaped quarter wavelength plate are rotatable about an optical axis parallel to a direction of light propagation through the optical unit.

According to some embodiments, the two or more controllable polarization dependent phase affecting elements comprises at least one liquid crystal phase affecting element.

According to some embodiments, the two or more controllable polarization dependent phase affecting elements are formed by two or more liquid crystal modulators positioned with alignment axes thereof being perpendicular between them, the optical unit may further comprise an input polarizer filter positioned to provide input light with linear polarization at a 45° angle with respect to the alignment axes of the liquid crystal modulators.

According to some embodiments, the optical unit may further comprise a controller connectable to the two or more controllable polarization dependent phase affecting elements and configured and operable to selectively adjust phase delay of the two or more controllable polarization dependent phase affecting elements.

According to some embodiments, the controller is configured to dynamically adjust the phase delay in response to an input control signal.

According to one other broad aspect, the present disclosure provides an optical unit comprising:
a first rotatable plate and a second rotatable plate, each comprising a ring-shaped retarder region surrounded by optically transparent regions and at least one polarization analyzer arranged along a common path of propagation of light through the optical unit;′
wherein the ring-shaped retarder regions are configured from a birefringent material having a fast axis and a slow axis; and
wherein selected rotation angles of the first and second rotatable plates provide selected attenuation and phase shift of ring-shaped light components within a range of 2π phase variation and 100% amplitude attenuation of light passing through the optical unit.

According to some embodiments, at least one retarder region of the first and the second rotatable plate comprise a quarter wavelength retarder region.

According to some embodiments, at least one retarder region of the first and the second rotatable plate comprise a half wavelength retarder region.

According to some embodiments, the retarder regions of the first and second rotatable plates comprises a first ring-shaped half wavelength plate and a second ring-shaped quarter wavelength plate, and wherein the first ring-shaped half wavelength plate and the second ring-shaped quarter wavelength plate are rotatable about an optical axis parallel to a direction of light propagation through the optical unit.

According to some embodiments, the optical unit may further comprise a controller connectable to the first and second rotatable plate and configured and operable to selectively adjust angular orientation of the first and second rotatable plate.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrate optical units according to some embodiments of the present disclosure;

FIG. 2 exemplifies an optical unit according to some embodiments of the present disclosure and illustrates the internal structure of the phase affecting elements;

FIG. 3 exemplifies an optical unit utilizing liquid crystal modulators and input polarizer filter according to some embodiments of the present disclosure

FIG. 4 illustrates an optical unit including three phase affecting elements according to some embodiments of the present disclosure;

FIG. 5 exemplifies a first phase affecting optical element according to some embodiments of the present disclosure;

FIG. 6 shows transmission of the optical unit in accordance with the angular position of the phase affecting optical elements according to some embodiments of the present disclosure;

FIG. 7 shows phase shift at output of the optical unit in accordance with angular position of the phase affecting optical elements according to some embodiments of the present disclosure;

FIG. 8 shows a map of transmission levels and phase shifts achievable using the optical unit according to some embodiments of the present disclosure;

FIG. 9 shows transmission of the optical unit utilizing liquid crystal modulators in accordance with different modulations of the liquid crystal modulator according to some embodiments of the present disclosure;

FIG. 10 shows phase shift at output of the optical unit in accordance with different modulations of the liquid crystal modulator according to some embodiments of the present disclosure;

FIG. 11 shows a map of transmission levels and phase shifts achievable using the optical unit utilizing liquid crystal modulators according to some embodiments of the present disclosure; and

FIG. 12 exemplifies a phase contrast microscope system including an optical unit according to some embodiments of the present disclosure.

### DETAILED DESCRIPTION OF EMBODIMENTS

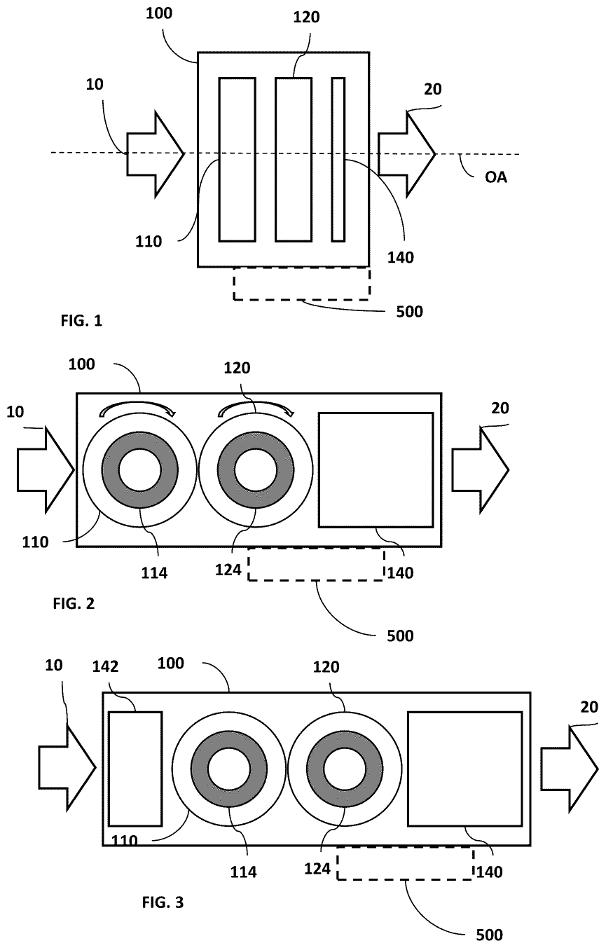

As indicated above, the present disclosure provides an optical unit configured and operable to controllably modulate the phase and/or amplitude of light using polarization properties of the light. Reference is made to FIGS. 1 and 2 exemplifying an optical unit 100 according to some embodiments of the present disclosure. FIG. 1 illustrates a side view of the optical unit, and FIG. 2 illustrates a side view, while showing faces of the optical elements and illustrates a schematic internal structure of the optical elements.

The optical unit 100 includes at least a first and a second polarization dependent phase affecting elements 110 and 120 positioned in path of light passing through the system, and a polarization analyzer 140 positioned downstream of the first and second polarization dependent phase affecting elements 110 and 120. The phase affecting elements 110 and 120 may be positioned on a rotatable mechanism, enabling selective rotation of the phase affecting elements about the optical axis OA of the unit 100. Generally, various reflecting or deflecting optical elements may be used, folding the optical axis OA, e.g., using one or more mirrors. The internal regions of the phase affecting elements are illustrated in FIG. 2 showing phase affecting regions 114 and 124 having a ring shape, surrounded by transparent regions. The phase affecting regions may be formed of birefringent materials, liquid crystal elements, or other polarization dependent retarder elements. More specifically, the phase affecting regions 114 and 124 are configured to apply a first phase shift to light components of one polarization orientation (with respect to axes of the phase-affecting region) and apply a second phase shift to light components of an orthogonal polarization orientation. For example, a first polarization orientation may correspond with a fast axis of a birefringent element and a second polarization orientation may correspond with a slow axis of the birefringent element. Rotation of the phase affecting elements 110 or 120 enable forming of a selected accumulated phase shifts to light 10 passing through the unit, to provide phase shifted output light 20. Additionally, selective rotation of the phase affecting elements 110 and 120 enable a rotation of polarization of light in accordance with level of phase shifts applied to light components of first and second polarization orientation.

At the output of the optical unit 100, the unit includes a polarization analyzer 140, e.g. a polarization filter. The polarization analyzer 140 filters out light components of a selected polarization orientation and transmits light components of a selected polarization orientation. This enables control of intensity of the output light 20, using selective rotation of polarization of light by the first and second phase affecting optical elements 110 and 120, and filtering out undesired polarization components using the polarization analyzer 140.

FIGS. 1 and 2 also exemplify controller 500 configured and operable to selectively vary orientation of the phase affecting elements 110 and 120. Controller may operate a rotating mechanism (e.g., wheel) to rotate the phase affecting elements 110 and 120 independently to selected orientations. In some embodiments, using liquid crystal modulators, the controller 500 may be configured and operable to apply selected voltage to the liquid crystal modulators to selectively adjust phase delay/shift to selected polarization orientations.

Accordingly, in one embodiment, the optical unit comprises two polarization-dependent phase-affecting elements 110 and 120 and a polarization analyzer 140. These components are arranged sequentially along a common optical path. The first phase-affecting element 110 is configured as a rotatable plate with a ring-shaped birefringent region 114, which modifies the phase of incoming polarized light. The second phase-affecting element 120 is separately rotatable and configured to provide a further phase modification to light components passing through the ring-shaped phase affecting region 124 thereof. The first 110 and second 120 phase affecting elements achieve together a combined modulation effect, enabling to apply a selected phase shift within a range of 2π radians, providing any selected phase shift to the output light 20. The polarization analyzer 140 is positioned at the output to filter the light based on its modified polarization state, resulting in precise control over phase and amplitude of output light.

Reference is made to FIG. 3 exemplifying an optical unit 100 utilizing liquid crystal modulators and an input polarizer 142 according to some embodiments of the present disclosure. In this configuration, the ring-shaped phase affecting regions 114 and 124 are formed by active regions of liquid crystal modulators. Phase affecting regions 114 and 124 may be formed by liquid crystal modulators positioned with their alignment axes being perpendicular between them. By applying an electric field across the liquid crystal layers, the birefringent properties are dynamically adjusted, enabling real-time control over the phase delay introduced by each element. This embodiment is particularly useful in applications requiring rapid, programmable phase modulation. In some embodiments, using liquid crystal modulators, the optical unit may further include an input polarizer 142. The input polarizer may be positioned with polarization orientation at a 45° angle with respect to the alignment axes of the liquid crystal modulators, which are perpendicular between them as indicated above. The use of liquid crystal modulators 114 and 124 enables electric control over the optical unit and does not require physical rotation of elements 110 and 120. Further, this configuration may provide additional control over phase variations.

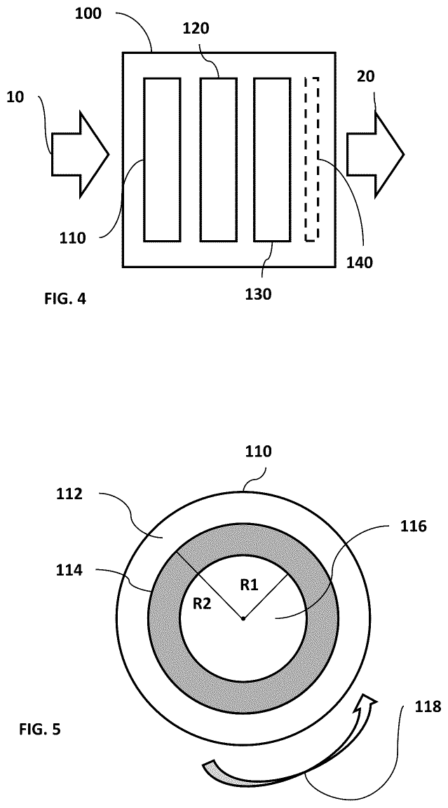

Generally, the use of two phase affecting elements 110 and 120 can provide full control over phase modulation of output light 20. However, some configurations of the optical unit according to the present disclosure may utilize an arrangement of three or more phase affecting elements, where at least two of the phase affecting elements are rotatable, and in some configurations all phase affecting elements are rotatable. FIG. 4 exemplifies an optical unit 100 that is configured with a first 110, a second 120 and a third 130 rotatable phase affecting optical elements, and a polarization analyzer 140. The use of three or more of the phase affecting elements may provide improved resolution and control over phase shift applied to output light 20 by the optical unit 100.

It should be understood that a distance between the optical elements 110, 120 and 140 of the optical unit 100 may be minimal, providing light components passing through the annular region of the first phase affecting optical elements 110 to continue and pass through the annular region of the second phase affecting optical element 120. This is while light components passing through surroundings regions of the first phase affecting optical elements 110 proceed and pass through the surrounding regions of the second phase affecting optical elements 120. Such distance may also be determined in accordance with divergence angle of the input light 10, for example, if the input light is collimated, the optical unit 100 may allow longer distance between the optical elements. Further, in some embodiments, various optical elements such as one or more lenses, mirrors, prisms etc., may be used to align passage of light components through the optical unit, and/or to enable folding of the optical axis in accordance with a desired physical configuration and packaging requirements.

It should be noted that the phase affecting regions of the polarization dependent phase affecting optical elements (110, 120 and optionally 130) used in the optical unit 100 are exemplified herein using annular regions for simplicity. The technique and optical unit of the present disclosure may utilize any selected shape and spatial structure of the phase affecting region in accordance with desired applications of the optical unit. For example, the phase affecting region may be of a circular shape, square, polygonal shape, or any other shape suitable for the specific applications. In some embodiments, the phase affecting region may take the entire surface of the polarization dependent phase affecting optical elements (110, 120 and optionally 130) providing attenuation and phase shift to light passing through the unit, without the use of surrounding light components.

Additionally, the order of the elements of the optical unit 100 is determined in accordance with direction of light transmission through the unit. More specifically, the polarization analyzer 140 is positioned at output of the optical unit 100, while the two or more phase affecting elements 110 and 120 are positioned upstream with respect to the polarization analyzer 140, to apply selected phase modulation to input light 10 prior to analyzing polarization thereof, and providing the output light 20.

As indicated above, the polarization dependent phase affecting elements used in the optical unit of the present disclosure include a ring-shaped phase affecting region surrounded by optically transparent regions. FIG. 5 exemplifies a configuration of the first phase affecting element 110, while typically the second phase affecting element 120, and additional one or more elements if used have a generally similar configuration. Accordingly, the polarization dependent phase affecting elements 110, 120 and optionally 130 according to some embodiments of the present disclosure are formed of a plate having an annular active region, having inner radius R1 and outer radius R2, surrounded by inner transparent circle region of radius R1 and outer regions defined regions external to radius R2. The transparent regions are configured to allow light transmission with minimal modulation, typically other than modulation associated with transmission of light through a transparent plate of uniform thickness. The phase affecting region 114 (or 124) may include a birefringent material and/or a liquid crystal modulators and configured to apply a selected phase shift variation between first and second orthogonal polarization components of the light. in some embodiments, the phase shift variation between the first and second orthogonal polarization components of light may be associated with half-wavelength and/or quarter wavelength of the light passing through the system.

For example, in some embodiments of the present disclosure, the first polarization dependent phase affecting element 110 utilizes a quarter wavelength phase affecting region and the second polarization dependent phase affecting element 120 utilizes a half-wavelength phase affecting region. In some other embodiments, the first polarization dependent phase affecting element 110 utilizes a half wavelength phase affecting region and the second polarization dependent phase affecting element 120 utilizes a quarter wavelength phase affecting region. In both these configurations, the polarization analyzer 140 may be a linear polarizer positioned at a selected or predetermined orientation while the first and second polarization dependent phase affecting elements 110 and 120 are selectively rotatable. FIGS. 5, 6 and 7 illustrate transmission and phase shift data achievable using different angular orientation of the first and second polarization dependent phase affecting elements 110 and 120.

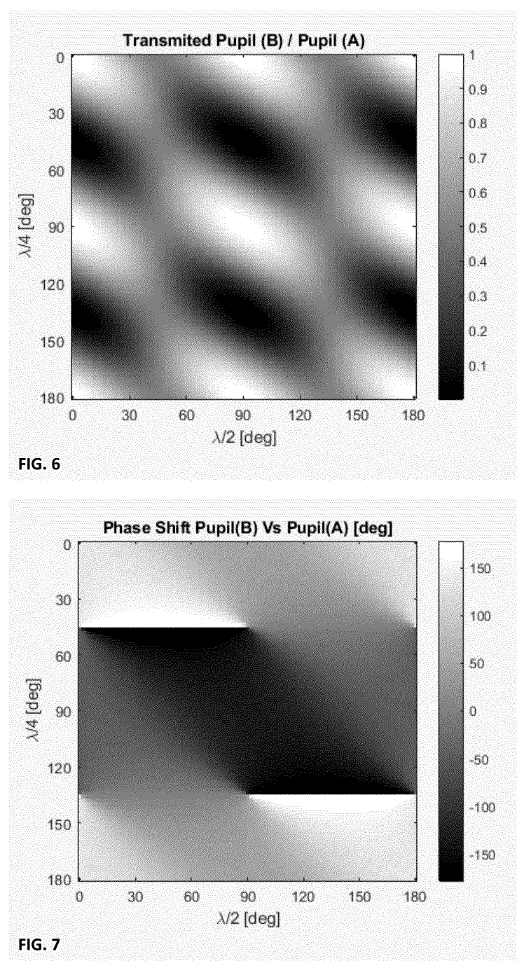

FIG. 6 shows transmission levels of the optical unit 100 in the exemplified configuration for different angular orientations of the polarization dependent phase affecting elements 110 and 120, within the annular region. Selective rotation angles of the phase affecting elements 110 and 120 enable rotation of polarization orientation of light passing through the unit, to provide output light having polarization orientation selected in accordance with angular orientation of the polarization analyzer 140. Thus, the polarization analyzer is used to limit transmission and provide output light having intensity in a range between 100% of input light intensity and complete blocking of light transmission. As indicated, the transmission is affected within the phase affecting ring-shaped region, while the transmitting regions provide almost full transmission of the light. For example, placing both the first and second phase affecting elements 110 and 120 at angles 0°, 90°, or 180° with respect to alignment direction of the polarization analyzer 140 provides full transmission. This is while placing one or the phase affecting elements 110 or 120, using a half wavelength region at angle 90°, and the other, using a quarter wavelength region at angle 45° or 135° with respect to polarization analyzer 140 provides complete blocking of light transmission within the annular region.

Similarly, FIG. 7 shows phase shift values between the phase of light components of the annular region and surrounding light components, in response to different angular orientations the polarization dependent phase affecting elements 110 and 120. As shown, the optical unit 100 can provide phase shifts within a range of 2π (or 360 degrees) in accordance with the selected orientations of the polarization dependent phase affecting elements 110 and 120. For example, placing one of the optical elements (110 or 120) using a quarter wavelength plate region at an angle around 45° with respect to orientation of the polarization analyzer 140, and the second phase affecting element (110 or 120) using a half wavelength plate region at an angle between 0° and 90° with respect to orientation of the polarization analyzer 140, provides almost a phase shift of ±π between light components of the annular region and surrounding light. Increasing the angle of the half wavelength plate region optical element above 90° eliminates this phase shift variation. Additional phase shifts can be obtained using selected angular relations as shown in the figure, ranging between −π (−180°) and +π (+180°).

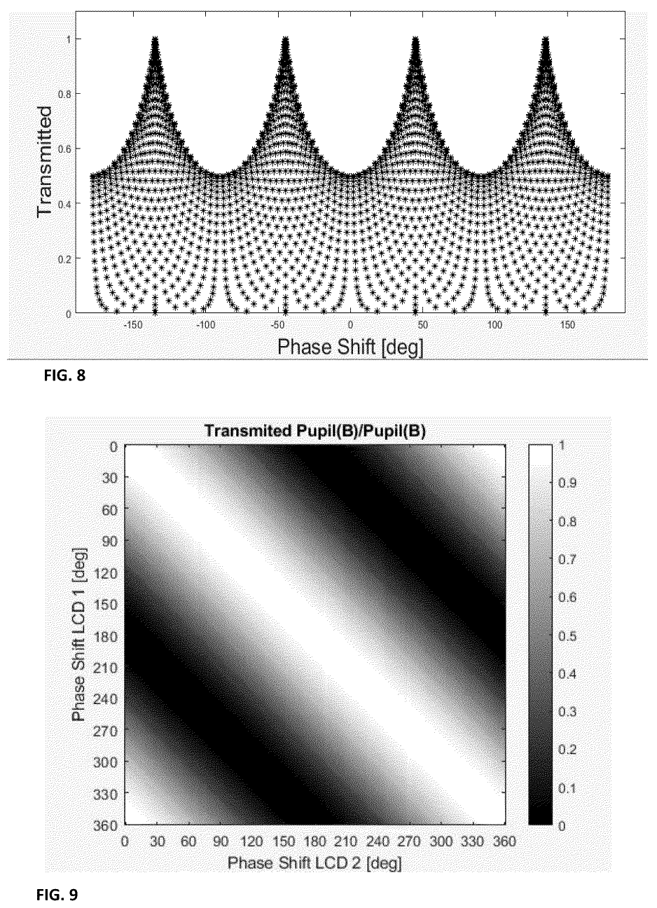

Further, FIG. 8 shows a map of various transmission values and corresponding phase shift variations obtainable by the optical unit 100 configures according to embodiments of the present disclosure and using a quarter waveplate phase region and a half wavelength phase region. As shown, the transmission values can range between zero, relating to full blocking and unity, relating to full transmission of light. Additionally, as shown, the optical unit 100 can apply a phase shift within a range between −180° (−π) and +180° (+π) between light components of the annular region and surrounding light components. This provides a phase shift range of 2π between light components passing through the annular region and light components passing through the surrounding regions.

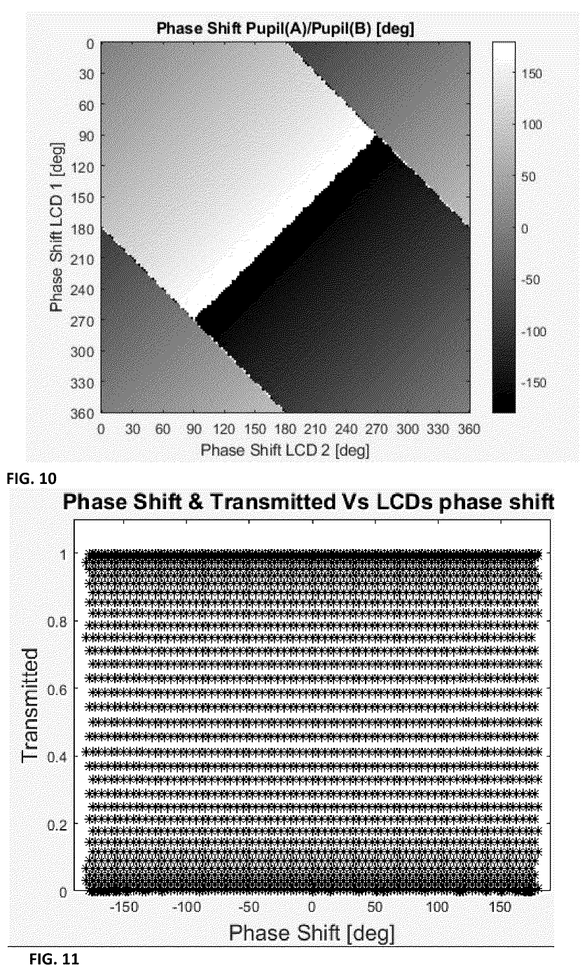

Additionally, and as indicated above with reference to FIG. 3, the optical unit of the present disclosure may utilize liquid crystal modulators. This configuration enables the use of selected modulation by the liquid crystal modulators to apply phase shift and/or attenuation to light passing through the optical unit. Reference is made to FIGS. 9, 10 and 11 exemplifying simulated results of transmission level (FIG. 9) and phase shift (FIG. 10) applied to light passing through the optical unit in accordance with phase shift applied by the first and second liquid crystal modulators of the optical unit. Further, FIG. 11 shows a map of various transmission values and corresponding phase shift variations obtainable by the optical unit 100 configures according to embodiments of the present disclosure and using liquid crystal modulators as exemplified in FIG. 3 above. As shown in FIGS. 9-11, the use of liquid crystal modulators enable full control (0-2π) over phase shift and attenuation of an optical signal passing through the optical unit, allowing to selectively adjust properties of the light passing through the unit by appropriate modulation of the liquid crystal modulators.

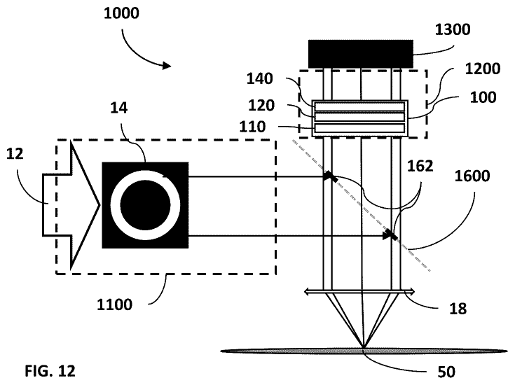

Reference is made to FIG. 12 exemplifying one possible use of an optical unit 100 according to some embodiments of the present disclosure. FIG. 12 exemplifies a reflection-based phase contrast microscope unit 1000 utilizing the optical unit 100 to provide phase variation between annular light components and surrounding light components. More specifically, the reflection-based phase contrast microscope unit 1000 includes an illumination channel 1100 configured to receive input illumination 12 and including an annular aperture 14, and a collection channel 1200 configured for collecting light reflected from a sample 50. The reflection-based phase contrast microscope unit 1000 may also include a beamsplitter, or a space variant beam splitting unit 1600 having an annular partly reflective region 162, objective lens 18 and output imaging arrangement 1300.

Generally, a reflection-based phase contrast microscope unit 1000 may suffer from a relatively low signal to noise ratio when using a fixed phase shift between light components of the annular region and surrounding light. The use of the optical unit 100 enables operation of the reflection-based phase contrast microscope unit 1000 with various phase shift and attenuation levels and selected a suitable phase shift and attenuation level providing optimal or maximal signal to noise ratio.

It should be noted that reflection-based phase contrast microscope unit 1000 is exemplified in FIG. 12 using an annular input illumination and phase shift optical unit 100 positioned in the collection path. In some embodiments, the direction of light passage through the reflection-based phase contrast microscope unit 1000 may be reversed, providing input illumination passing through optical unit 100, directed to the sample via objective lens 18, and collected through annular aperture 14. In such configuration, order of elements of the optical unit is reversed, providing that the polarization analyzer 140 is downstream with respect to the polarization dependent phase affecting elements 110 and 120. Further, the reversed configuration may be suitable for scanning applications using the reflection-based phase contrast microscope unit 1000.

Accordingly, as discussed above, the present disclosure provides an optical unit configured and operable for providing a selected, continuously varying phase shift and attenuation to light components of a selected spatial region of a beam passing through the optical unit. Selection of phase shift and attenuation levels can be determined in accordance with selected rotation angle of the phase affecting optical elements of the optical unit. This enables simple and direct control over phase and amplitude of light collected from, or transmitted toward, a sample object, enabling selective modulation of light phase and amplitude. It should be understood that the phase affecting region is exemplified herein using an annular region, while the technique of the present disclosure may relate to any selected shape and spatial structure of the phase affecting region.

It is to be noted that the various features described in the various embodiments can be combined according to all possible technical combinations.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based can readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

1. An optical unit comprising:
two or more controllable polarization dependent phase affecting elements, each having a ring-shaped phase affecting region surrounded by transmitting regions;
and at least one polarization analyzer;
wherein the two or more controllable polarization dependent phase affecting elements and the at least one polarization analyzer being arranged along a common path of light propagation through the optical unit.

2. The optical unit of claim 1, wherein the two or more controllable polarization dependent phase affecting elements are formed of rotatable plates carrying birefringent materials having a fast axis and a slow axis both perpendicular to direction of propagation of light through the material.

3. The optical unit of claim 2, wherein the two or more controllable polarization dependent phase affecting elements comprises at least one of a half wavelength plate or a quarter wavelength plate.

4. The optical unit of claim 2, wherein the two or more controllable polarization dependent phase affecting elements comprises a first ring-shaped half wavelength plate and a second ring-shaped quarter wavelength plate, and wherein the first ring-shaped half wavelength plate and the second ring-shaped quarter wavelength plate are rotatable about an optical axis parallel to a direction of light propagation through the optical unit.

5. The optical unit of claim 1, wherein the two or more controllable polarization dependent phase affecting elements comprises at least one liquid crystal phase affecting element.

6. The optical unit of claim 5, wherein the two or more controllable polarization dependent phase affecting elements are formed by two or more liquid crystal modulators positioned with alignment axes thereof being perpendicular between them, the optical unit may further comprise an input polarizer filter positioned to provide input light with linear polarization at a 45° angle with respect to the alignment axes of the liquid crystal modulators.

7. The optical unit of claim 1, further comprising a controller connectable to the two or more controllable polarization dependent phase affecting elements and configured and operable to selectively adjust phase delay of the two or more controllable polarization dependent phase affecting elements.

8. The optical unit of claim 7, wherein the controller is configured to dynamically adjust the phase delay in response to an input control signal.

9. An optical unit comprising:
a first rotatable plate and a second rotatable plate, each comprising a ring-shaped retarder region surrounded by optically transparent regions and at least one polarization analyzer arranged along a common path of propagation of light through the optical unit;′
wherein the ring-shaped retarder regions are configured from a birefringent material having a fast axis and a slow axis; and
wherein selected rotation angles of the first and second rotatable plates provide selected attenuation and phase shift of ring-shaped light components within a range of 2π phase variation and 100% amplitude attenuation of light passing through the optical unit.

10. The optical unit of claim 9, wherein at least one retarder region of the first and the second rotatable plate comprise a quarter wavelength retarder region.

11. The optical unit of claim 9, wherein at least one retarder region of the first and the second rotatable plate comprise a half wavelength retarder region.

12. The optical unit of claim 9, wherein the retarder regions of the first and second rotatable plates comprises a first ring-shaped half wavelength plate and a second ring-shaped quarter wavelength plate, and wherein the first ring-shaped half wavelength plate and the second ring-shaped quarter wavelength plate are rotatable about an optical axis parallel to a direction of light propagation through the optical unit.

13. The optical unit of claim 9, further comprising a controller connectable to the first and second rotatable plate and configured and operable to selectively adjust angular orientation of the first and second rotatable plate.
